(19) United States
(12) Patent Application Publication
(10) Pub. No.: US 2021/0208753 A1
(43) Pub. Date: Jul. 8, 2021

(54) GENERATING A USER-SPECIFIC USER INTERFACE

(71) Applicant: Commonwealth Scientific and Industrial Research Organisation, Acton (AU)

(72) Inventors: Kun Yu, Acton (AU); Shlomo Berkovsky, Acton (AU)

(21) Appl. No.: 16/956,088

(22) PCT Filed: Dec. 21, 2018
(86) PCT No.: PCT/AU2018/051376

§ 371 Date: Jun. 19, 2020

(30) Foreign Application Priority Data
Dec. 21, 2017 (AU) 2017905135

(51) Int. Cl. G06F 3/0484; G06F 9/451; G06Q 30/06; G06N 20/00; G06F 3/01; G06F 3/0481

(52) U.S. Cl. CPC G06F 3/0484; G06F 9/451; G06Q 30/0641; G06F 3/013; G06F 3/015; G06F 3/0481; G06N 20/00

(57) ABSTRACT

The present disclosure generally relates to generation of a user-specific user interface. Specifically, there is provided a computer implemented method (600) for generating a user-specific user interface (612). The method (600) comprises a learning phase and an execution phase. The learning phase comprising presenting one or more pre-defined tasks to a user, the pre-defined tasks including pre-defined task features (602), capturing user interaction features while the user completes the pre-defined tasks (604), capturing a user decision input indicative of a decision by the user on the one or more pre-defined tasks (606), and creating a user-specific trust model that models the relationship between the pre-defined task features, the user interaction features and the user decision input (608). The Execution phase comprising evaluating the user-specific trust model on current task features (610) and based on evaluating the user-specific trust model on the current task features, selectively including user interface elements into the user interface to thereby generate a user-specific user interface (612).

### CROSS-REFERENCE TO RELATED APPLICATIONS

The present application claims priority from Australian Provisional Patent Application No 2017905135 filed on 21 Dec. 2017, the contents of which are incorporated herein by reference in their entirety.

### TECHNICAL FIELD

The present disclosure relates to a computer-implemented method, software, device and system to generate a user-specific user interface.

### BACKGROUND

User interfaces on computer systems, such as mobile phones and personal computers, and devices including machines become more and more complex. At the same time, users of these systems differ significantly in how they use these devices. As a result, user interfaces that are useful for some users are not useful for others. This leads to reduced user satisfaction and sub-optimal decision making.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

There is provided a method for generating a user-specific user interface. This method uses a model that is trained for each user individually and that describes how that specific user bestows trust upon different functionalities or features of a user interface. It is then possible to provide to the user only those functionalities that the user trusts.

When reference is made to a user interface herein, this is not limited to a graphical user interface displayed on a computer screen but also encompasses physical user interfaces comprising hardware controls, such as radio buttons and switches.

A method for generating a user-specific user interface comprises:

a learning phase comprising:
presenting one or more pre-defined tasks to a user, the pre-defined tasks including pre-defined task features,
capturing user interaction features while the user completes the pre-defined tasks,
capturing a user decision input indicative of a decision by the user on the one or more pre-defined tasks, and
creating a user-specific trust model that models the relationship between the pre-defined task features, the user interaction features and the user decision input; and

an execution phase comprising:
evaluating the user-specific trust model on current task features; and
based on evaluating the user-specific trust model on the current task features, selectively including user interface elements into the user interface to thereby generate a user-specific user interface.

The user interface may comprise one or more of:

graphical user interface;

a machine or device user interface; and

an online shop interface.

The user interface elements may be sale items.

The user interface elements may be options or controls.

A computer implemented method of predicting a decision of a user comprises:

receiving first task data associated with a first task performed by the user;

determining a reliability level based on the first task data;

determining a reliability model for the user based on the reliability level;

receiving second task data associated with a second task performed by the user; and

predicting a decision of the user based on the reliability model and the second task data.

Human-machine (or human-system) trust plays a key role in affecting the way people work with intelligent systems: proper trust posited by a human is beneficial to the human-system collaboration, saving human effort and improving collaborative performance, while improper trust, e.g. a user trusts a system more than warranted or distrusts a reliable system, may lead to inappropriate system use or even task failure. An advantage of this method is the calibration of trust and the application of a trust model to decide whether a device can gain a specific user's trust and/or whether some information or service is suitable for a specific user's trust profile. A direct impact is that information delivery mechanism can be customized to fit the needs of different users. For a given user, based on the trust profile, the use decision can be predicted, which can be a useful tool to extend the way that human interacts with computers: the decision execution efficiency can be much improved, in an automatic way. This quantifies the trust of users, and via the qualitative comparison of the trust levels of different users, it will facilitate product design in that the designers can make accurate decisions on which feature will enhance the trust of one specific category of users.

The second task data may be associated with a device.

The prediction of the user may comprise predicting a decision of the user to control the device.

The computer implemented method may further comprise determining first user decision data based on the first task data.

The computer implemented method may further comprise determining user behaviour data based on the first task data.

Determining the reliability model may be based on the first task data, the reliability level, the first user decision data and user behaviour data.

The computer implemented method may further comprise predicting the reliability level.

The computer implemented method may further comprise predicting the user-machine performance.

An output of a computer system may be changed based on one or more of:

the predicted decision of the user;

the reliability level; and

the user-machine performance.

Changing the output of the computer system may include changing the user interface to manage the flow of information.

The reliability model for the user may be constructed by supervised machine learning methods.

The supervised machine learning method may be an artificial neural network.

The inputs to the reliability model may comprise one or more of:

task parameters for a set of standard tasks;

user behaviour based on the first task data;

user decision based on the first task data; and

reliability level based on the first task data.

The task parameters for the set of standard tasks may include one or more of:

category;

difficulty; and

presentation.

The computer implemented method may further comprise receiving data representing physiological signals of the user and wherein the user behaviour includes physiological signals.

The user decisions based on the first task data may include:

yes;

no; and

maybe.

The reliability level may include:

relatively high; and

relatively low.

Software, being machine readable instructions, when performed by a computer system causes the computer system to perform the above method.

A computer system for predicting a decision of a user comprises:

a processor:
to receive first task data associated with a first task performed by the user;
to determine a reliability level based on the first task data;
to determine a reliability model for the user based on the reliability level;
to receive second task data associated with a second task performed by the user; and
to predict a decision of the user based on the reliability model and the second task data.

The learning phase further comprises determining critical features from the pre-defined task features and creating a user-specific trust model that models the relationship between the critical features, the user interaction features and the user decision input.

The one or more pre-defined tasks are presented to the user through a first user interface and the current task features are provided through a second user interface.

The first user interface is different from the second user interface.

The first interface is associated with a first device and the second interface is associated with a second device, wherein the first device is different from the second device.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

An example will now be described with reference to the following drawings:

FIG. 1 illustrates an exemplary overview of the system that implements a method for predicting a decision of a user.

FIG. 2 extends the example of FIG. 1 and illustrates a new example system and information flows.

FIG. 3 illustrates choices that the system provides.

FIG. 4 illustrates different layers of model construction and evaluation.

FIG. 5 is an example decision tree.

FIG. 6 illustrates method for generating a user-specific user interface.

### DESCRIPTION OF EMBODIMENTS

This disclosure provides a method for generating a user-specific adaptive system, while the idea is interpreted via the following example of user interface adaptation based on determining a trust model for each user. Throughout this description trustworthiness is used together with reliability as synonyms of each other. Trust may refer to the user side of the trusting relationship, while trustworthiness may depict the system-side characteristics of being trusted. The disclosure will first describe the calibration of reliability (i.e. trustworthiness) and then describe a method for generating a user-specific user interface as an example of trust-based user adaptive system.

There is also provided an interaction system where the trust does not limit to the interface alone but some functions, modules or parameters of a system can also result in trust.

The following disclosure describes the calibration (i.e. training) of reliability and application of a reliability model. The reliability model can be used to decide whether a device is determined to be reliable or can be used as a trust model. For a given user, the user decision can be predicted based on the reliability model, which can be a useful tool to extend the way that humans interact with computers, because not all tasks performed by computers are as reliable as other tasks. In this way, decision execution can be automated and efficiency can be improved.

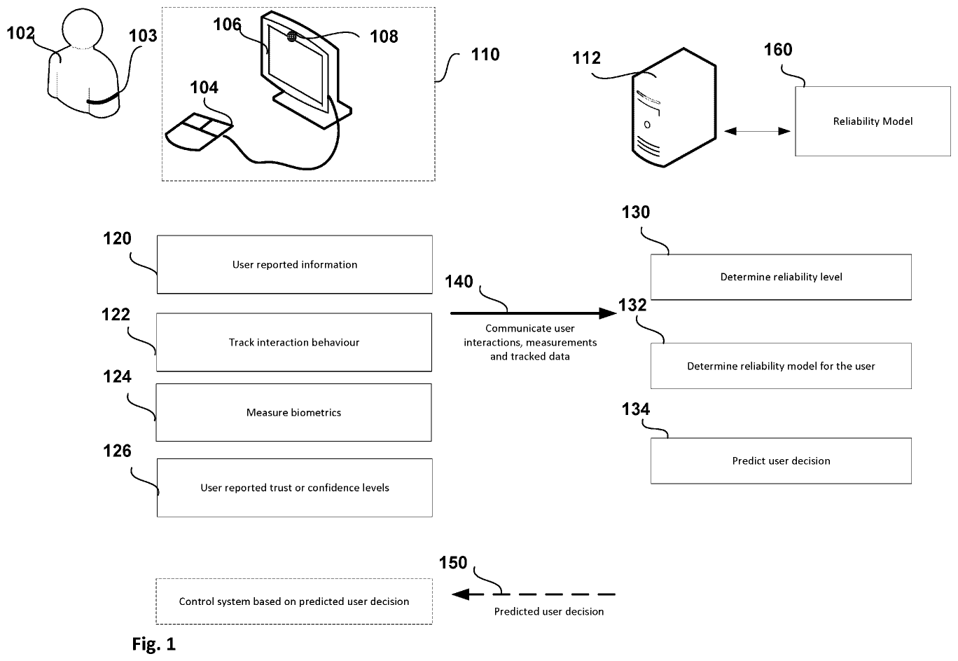

FIG. 1 illustrates an exemplary overview of the system that implements a method for predicting a decision of a user. The method comprises receiving first task data associated with a first task performed by the user; determining a reliability level based on the first task data; determining a reliability model for the user based on the reliability level; receiving second task data associated with a second task performed by the user; and predicting a decision of the user based on the reliability model and the second task data.

In this example, the user 102 is interacting with a customised automation system 110. The system 110 comprises a mouse 104, a display 106, and a video capture device 108. The user is wearing a device 103 that measures heart rate which is in communication with the system 110.

In this example the user 102 registers his own information in the system 110. This information can be collected using questionnaires 120 where the questions can be directed to their preferred way of interaction, their device usage habits, and similar behavioural features. The questions may also be based on historical interaction data.

The system 110 tracks 122 the user's interaction behaviour, such as the decisions made by the user, and measures 124 biometric data of the user, such as galvanic skin response (GSR), electroencephalography (EEG), and eye tracking signals. The system 110 will also collect information (such as by again utilising a questionnaire) about the self-reported trust or confidence levels of the user 126.

System 110 then communicates the data to an external server 112. The server 112 then determines a reliability level 130 of the user based on the user's interactions. The server 112 then also determines the reliability model 132 for the user. The server 112 monitors the automation system's 110 parameters including its accuracy, reliability and method of presentation. The automation system 110 will be used for training the reliability model, during which the features that are critical for the reliability model training will be determined. Again, the same process can be used by server 112 to train a trust model.

When the user interacts with a new system, the parameters of the new system, together with the features selected by the trust model will be combined and processed in the reliability model. The model will calculate the user's reliability level, and predict his or her decision pattern.

The output of the trust model may be the input of a control module. In this example of FIG. 1 the automated system is controlled by a predicted user decision 134 communicated 150 to the system 110. This can be done for example if a low level of perceived reliability is identified which is considered detrimental to the human-system collaboration, specified commands may be triggered, such as adjustment of the running mode or output of the automation system 110. In further examples, a user interface is adjusted to a user-specific user interface that increases the trust of the user into the user interface. The commands may aim to improve the reliability level of the user and hence ensure the human-machine collaboration efficiency.

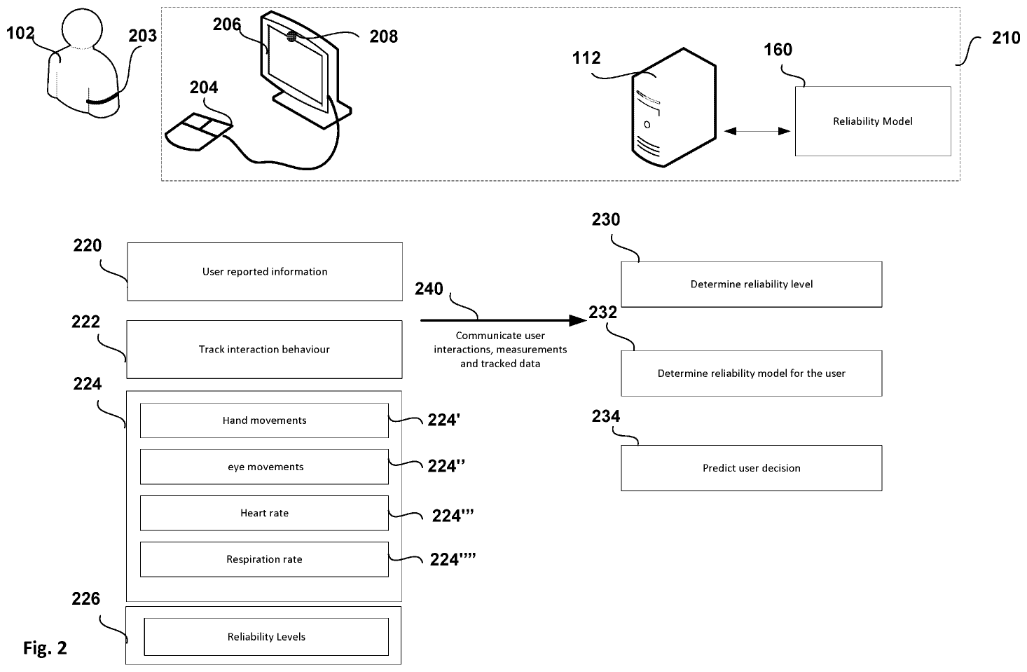

FIG. 2 extends the example of FIG. 1 and illustrates a new example system 210 and information flows. In this example the reliability model 160 that was constructed in the example of FIG. 1 is part of the system rather than external to the system as in FIG. 1 and provides the system with information about customising a shopping experience for the user 102. In this example, the second task user 102 is looking at purchasing a new juicer for his home. Although the user 102 is familiar with home appliances, blenders and mechanical juices, he has never used an electric juicer before.

The user 102 is asked to operate several electric devices and his physiological features are measured. The system 200 utilises a number of physiological measurements to predict the decision of the user 202. As with the example system in FIG. 1, there is a heart rate monitor 203, a mouse 204, a display 206 and a video capture device 208. The video capture device 208 can be used to monitor visual behaviours of the user and may include monitoring head movements, tracking eye motions and monitoring hand movements.

The system 210 has a number of modules for measuring physiological features 120, that include modules for measuring hand movements 224′, measuring eye movements 224″, measuring heart rate 224′″ and measuring respiration rate 224″″.

The system 210 prepares a questionnaire based on the user's online shopping interest and reliability profile. An exemplary questionnaire is shown as follows:

Please select which category of items you are interested to buy online:
(a) Art (b) Computers (c) Health & beauty (d) Home appliance

In this example, the user has selected one category, home appliance. In response the system 210 determines that the next question will be:

Please let us know which of the following items you are interested in?

(a) Electric juicer (b) Vacuum cleaner (c) Electric fan (d) Hot water system

The system 210 may generate similar refined questions until one specific item is determined for the user. In this example, the system has generated enough refined questions to determine that the user is interested in electric juicers.

Once it has been determined that the user is interested in electric juicers, the system 210 can determine 232 a reliability model 160 that predicts perceived reliability of electric juicers.

Please check and compare the following electric juicers. To provide better recommendation service, we may need to use your behavioral and GSR data to construct the reliability model.
www.ebay.com/item=ejuicer1
www.ebay.com/item=ejuicer2
www.ebay.com/item=ejuicer3
and rate how much you believe:

The juicer is able to function properly and meet your needs.

It is easy.to understand how the juicer works.

The seller is able to provide good products and quality service.

The brand of the juicer can be trusted.

Please rate 1 to 5 for each of the above statements, where 1 indicates you are totally disagree with the statement, while 5 means you totally agree with the statement.

In this example, the system measures the user's biometric data 224. When the user 102 checks the respective web sites to compare the products, his eye and mouse movements will be captured along with time stamps. In this example, a galvanic skin response (GSR) signal is collected all through the comparison process using the band worn by the user on the arm 203.

In this example, the mouse 204 cursor of the user 102 stays at the product description part of the webpage, and at the same time the user's sights are focused on the motor power of the juicer. The user 102 doesn't spend much time on the juicers with motor powers lower than 2000 watts. The user goes back to check the reviews of the products from other customers, however based on eye tracking he is only interested in the negative reviews, and spends more than 5 seconds on each of them. The user also checks the warranty of the juicers, however he scrolls the webpage quickly, and doesn't check the warranty information for all four juicers.

The system will track and collect user interaction data 222. In this example, the following decisions and performance are collected:
the juicer the user has spent most time on;
the juicer the user has spent least time on; and
The respective ratings for the juicers as mentioned above.

As in this example, the system stores, collects or queries information about the products. For example, the system 210 stores the reviews on each juicer so it can be established that the user is spending the most time on the juicer with the most positive reviews. Similarly, the system 210 stores data about the power of each juicer, so it can be established that the user is spending less time on juicers with the least power. It is not necessary for the system 210 itself to store the data and the relevant data could be queried from a third party data source over a communication network such as the internet.

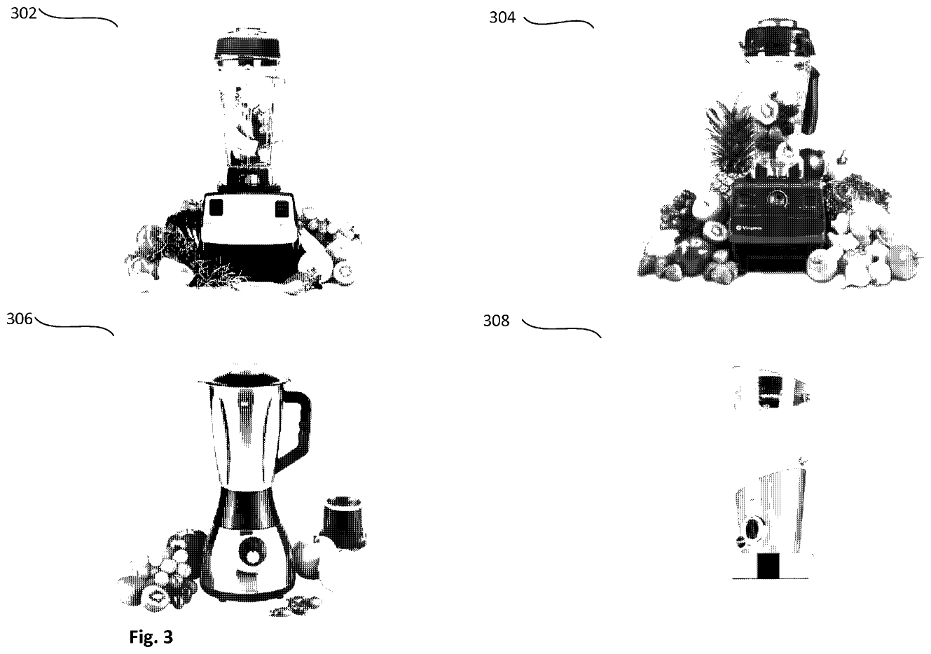

FIG. 3 illustrates the choices that the system provides based on the user reported information 220, the interaction behavior 222, the biometric data 224 and the reliability levels 226. In the example in FIG. 3, the first juicer 302 is powerful and has the most positive reviews. The second juicer 304 is the most powerful, but has less positive reviews. The third juicer 306 is powerful but has the most negative reviews. The fourth juicer 308 is the least powerful and has the second most negative reviews. The user 102 spends very little time on the juicer 308 as it is not powerful enough. The user 102 spends a substantial amount of time on juicer 306 but appears to be negatively affected by the negative reviews of the juicer.

### Further Details

### Trust

Various definitions can be proposed to represent user trust in human-machine interactions. One definition is where ‘trust can be defined as the attitude that an agent will help achieve an individual's goals in a situation characterized by uncertainty and vulnerability.’

Human-automation trust can be described in three layers of variability: dispositional trust, situational trust and learned trust.

Dispositional trust reflects the user's natural tendency to trust machines and encompasses cultural, demographic, and personality factors.

Situational trust refers to more specific factors, such as the task to be performed, the complexity and type of system, a user's workload, perceived risks and benefits, and even mood.

Learned trust encapsulates the experiential aspects of the construct which are directly related to the system itself. This variable is further decomposed into two components. One is initial learned trust, which consists of any knowledge of the system acquired before interaction, such as reputation or brand awareness. This initial state of learnt trust is then affected by dynamic learned trust which evolves as the user interacts with the system and begins to develop experiential knowledge of its performance characteristics such as reliability, predictability, and usefulness.

In this disclosure, the system generates an objective measurement of trust based on the user's response, behaviour and physiological and biometric measurements. That is, the system in this disclosure utilises an objective measurement of trust rather than a determination of the individual user's subjective trust. This distinction is important because the system does not propose to make predictions about the user's subjective trust rather the system only makes predictions about the objective measured trust, which may materially make a difference in predictions if the objectively measured trust does not equate to the subjective trust for the user. In this sense, this disclosure refers to the term reliability to mean objective measurements of the trust of the user. It is noted that the determination of trust becomes a technical processes akin to monitoring the physical parameters of a technical system.

### Constructing a Reliability Model

The reliability model can be used to predict a decision of the user based on the behaviour and task context. Each of the physiological measurements become an input into the reliability model. The user decision can be predicted based on these measurements.

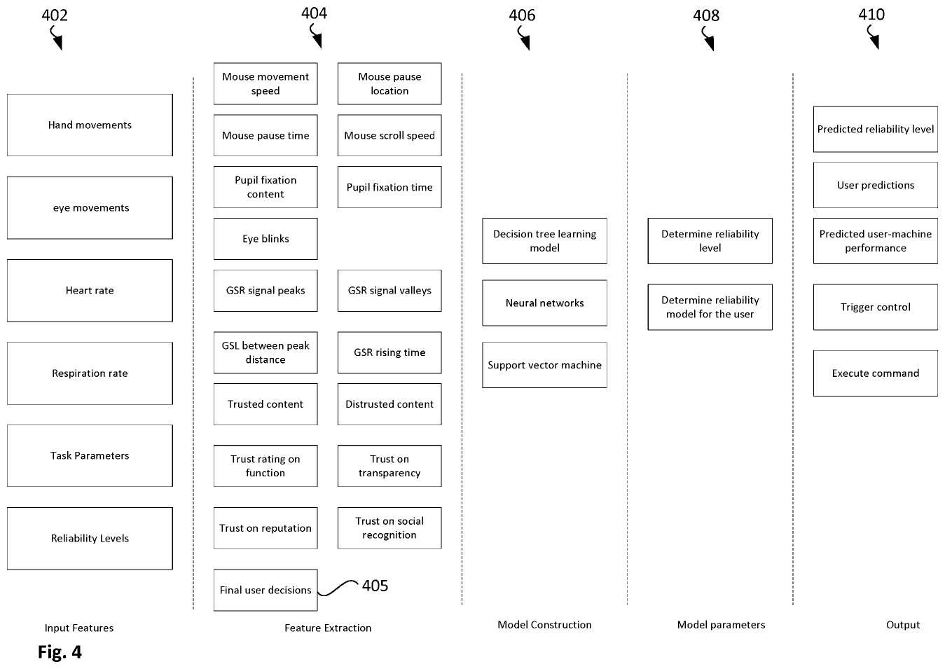

FIG. 4 illustrates different layers of model construction and evaluation. There is a set of input features 402, which are measured while the user interacts with the user interface. Then, there is a feature extraction layer 404, which transforms the measured data into features that can be used as parameters of the model. The raw measurements may be converted to a single numerical feature. For example, server 112 analyses the eye movements to detect blinks and calculates a blink rate of blinks per minute as a numerical value, which can be used in a machine learning method to create a model. During model construction 406 server 112 constructs one or more models such that the models can most accurately represent the relationship between the input features 402 and measured decisions (or output features) made by the user. In FIG. 4, the final user decisions are also illustrated in the feature extraction level 404 indicated at 405.

Once server 112 has constructed the model, server 112 trains the model by calculating the model parameters 406. In general terms, a model is a mathematical rule to estimate an output based on inputs. The mathematical rule includes a number of parameters, such as weights of a weighted sum of inputs. During training, server 112 considers training samples providing input and output feature values and tunes the model parameters, such that the output calculated by the model is as close as possible to the actually observed output in the training samples. Basically, this involves calculating internal parameters such that the difference between the model output and the observed output is minimised across all learning samples. Finally, the model can be evaluated to calculate the output 408-410. This means providing current input feature values where the output is not known because the user has not yet interacted with the current user interface. Using the model, server 112 can predict the output before the user provides the output by interacting with the user interface.

As an example, the following behavioural signals may be extracted:
The movement of the mouse, clicks of buttons and scroll of the mouse scroller;
The movement of eyes, and the focus of sight;
The GSR signal aligned with the motions of mouse and eyes via time stamps.

The system 210 may track a number of features of the mouse input including mouse movement speed, mouse pause time, mouse pause location, and mouse scroll speed. Similarly the system may track a number of features about the eyes of the user including pupil fixation content, pupil fixation time, and eye blinks.

The behavioural and physiological features can be extracted, including:
GSR signal peaks;
GSR signal valleys;
GSR between-peak distance; and
GSR rising time.

The trust-related features can be extracted, including:
Trusted content;
Distrusted content;

The corresponding trust related responses include:
Trust ratings on function;
Trust on transparency;
Trust on reputation;
Trust on social recognition;
Final user decisions.

The learning samples mentioned above include the data measured during the user interaction as well as features from the current task provided through the user interface. The data may come in records of the form

{x, Y)=(x_{1},x_{2},x_{3}, . . . ,x_{k},Y)}

where x is the input variable (input feature) and Y is the user decision (label). Therefore a vector of input feature values (x₁, x₂, x₃, x₄) can be constructed from the input variables for a given task.

As illustrated in FIG. 4, the reliability model can be constructed, amongst other approaches, utilising decision tree learning model, or random forest, neural networks or support vector machine and etc. Typically the model would be constructed utilising supervised machine learning methods of which a decision tree learning method is one example. A decision tree is a simple representation for classifying examples. A decision tree is useful as a predictive model, as it can be used to take observations about items to conclusions (and predictions) about the item. In this disclosure, the preferred implementation of the reliability model utilises a unique form of decision tree which takes trust as an input and makes predictions about the trust of the user as associated with specific items or actions performed by a system. A tree construction method such as information gain which is used in the ID3 (Iterative Dichotomiser 3) and C4.5 tree generation algorithms may be used.

C4.5 builds decision trees from a set of training data in the same way as ID3, using the concept of information entropy. The training data is a set S=s₁, s₂, . . . of already classified samples. Each sample sᵢ consists of a p-dimensional vector x_{1,i}, x₂ᵢ, . . . , x_{p,i}), where the xⱼ represent attribute values or features of the sample, as well as the class in which sᵢ falls.

At each node of the tree, C4.5 chooses the attribute of the data that most effectively splits its set of samples into subsets enriched in one class or the other. The splitting criterion is the normalized information gain (difference in entropy). The attribute with the highest normalized information gain is chosen to make the decision. The C4.5 algorithm then recurs on the smaller subsets.

This algorithm has a few base cases.

All the samples in the list belong to the same class. When this happens, it simply creates a leaf node for the decision tree saying to choose that class.

None of the features provide any information gain. In this case, C4.5 creates a decision node higher up the tree using the expected value of the class.

Instance of previously-unseen class encountered. Again, C4.5 creates a decision node higher up the tree using the expected value.

In pseudocode, the general algorithm for building decision trees is:

1) Check for the above base cases.
2) For each attribute a, find the normalized information gain ratio from splitting on a.
3) Let a_best be the attribute with the highest normalized information gain.
4) Create a decision node that splits on a_best.
5) Recur on the subset obtained by splitting on a_best, and add those nodes as children of node.

More details can be found in S. B. Kotsiantis, Supervised Machine Learning: A Review of Classification Techniques, Informatica 31(2007) 249-268, 2007, which is included herein by reference and are available under http://www.rulequest.com/.

The reliability model could also be implemented as an artificial neural network or constructed using other machine learning approaches (such as a support vector machine). However, there are some benefits to using a decision tree model. In particular it is useful that a given situation for prediction is easily observable in the model, by contrast an artificial neural network is often difficult to understand how the prediction was made and the most important features for making the decision. This is because the neural networks assigns a number of weights to a number of layers of neurons between the input and the output layers and it is generally not simple to ascertain what the weights mean in terms of the most important features.

In some embodiments it is possible to implement the model as a combination of decision trees and a neural network (and possibly other approaches) which can be combined to determine a prediction. Used in this way, a neural network may for example be beneficial to counteract overfitting of the data to the decision tree, changes in training data that may result in significant changes to the decision tree model or simply to improve the accuracy of the predictions performed by the model.

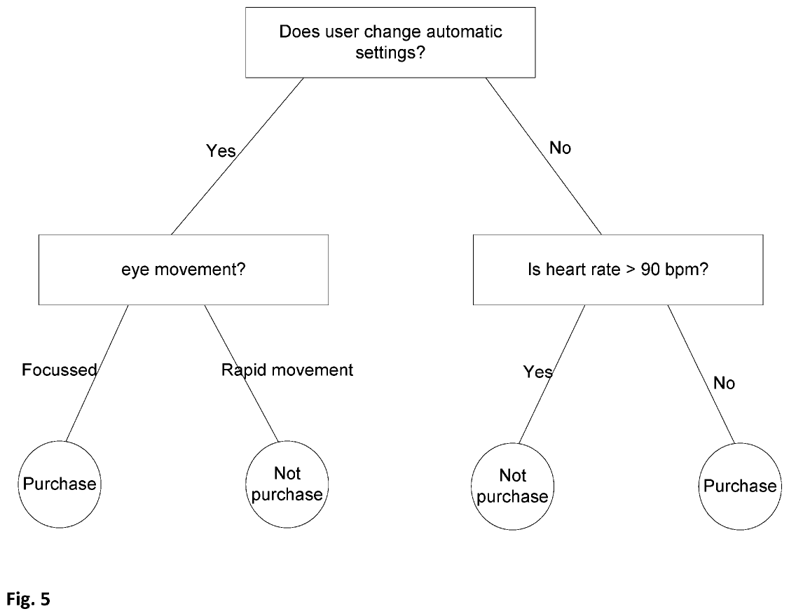

FIG. 5 is an example decision tree for the user that has been constructed from the input data. This example decision tree is simplified for illustrative purposes and in practice the decision tree could be significantly more complex. In this example, there is a single target outcome which is the predicted decision of the user. A decision tree is a tree in which each internal (non-leaf) node is labelled with an input feature. The edges coming from a node labelled with an input feature are labelled with each of the possible values of the user decision or the edge leads to a subordinate decision node on a different input feature.

In this example, the first element in the tree is the input variable “does the user change automatic settings?” This input may be measured from task data or in combination with visual monitoring of the user. If the answer to the first question is yes, then the next step is to determine the user's eye movement. If the user eye movements are relatively stable then the predicted decision is for the user to purchase the oven. If the user's eye movements are rapidly changing, then the predicted decision is ‘not purchase’.

If the user does not change the automatic settings, then the next query is to determine what the user's heart rate is. If the user's heart rate is over 90 beats per minute (90 bpm) then the predicted outcome is ‘not purchase’. If the user's heart rate is 90 or less then the predicted decision is ‘purchase’.

The procedure described above may need to be conducted for several iterations before a reliable set of features with corresponding trust responses are collected.

To build a trust model for user decision prediction, the trusting features will be fed to a model, for example, Support Vector Machine (SVM) with corresponding user decisions. A typical supervised model training procedure will be conducted and the trust model can be constructed.

### Outputs of the Reliability Model

While some outputs have been described herein, others are also possible. These include a predicted reliability or trust level, a prediction of user interaction, such as a decision by the user, a predicted user-machine performance. The output may also comprise a trigger for a control, such as a trigger to control a machine to perform a certain action, or to execute a command, such as a program command on a computer system.

### Predictions

The reliability model 160 in FIG. 1 models the relationship between user behaviours and task parameters as inputs, and the user decisions and reliability levels as outputs. Therefore the system 110 can, in the context of a new task, take measurements of the user's behaviour and input both the task parameters and behavioural features into the reliability model. For a new task, when given the user's behaviour and task parameters as inputs, the reliability model can predict or evaluate the user's perception of reliability. Similarly, the reliability model can predict the user's decisions with the same inputs, as well as the predicted user-machine performance.

There may be three types of predictions:
predicted reliability level;
predicted decisions; and
predicted performance.

### Reliability Level

A reliability level assists in identifying what types or characteristics of information or devices are capable of affecting the user's measure of reliability and which cannot. Reliability level can be used for product design, information propagation and usability. The reliability level is a quantitative measure of the reliability of a device or product from the user's perspective.

### Predicted Decisions

Predicted decisions can be used to change the user interface in a way that will streamline the user experience. For example, if the system 110 predicts that a user will not click on a link because the link is unreliable then that link may not be displayed to the user, or hidden. This can save the user's time and improve the user's experience.

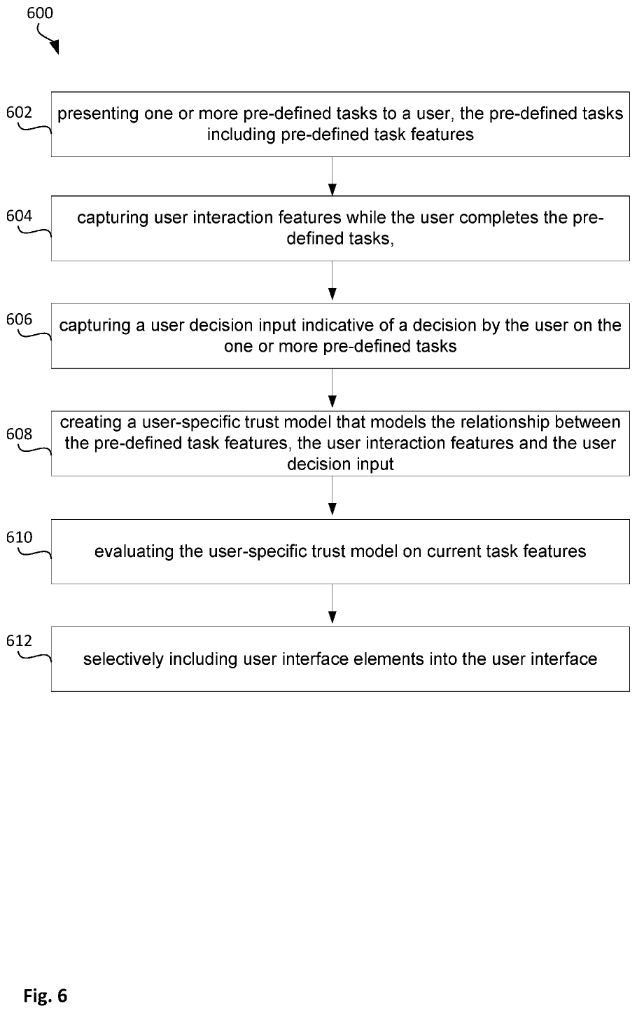

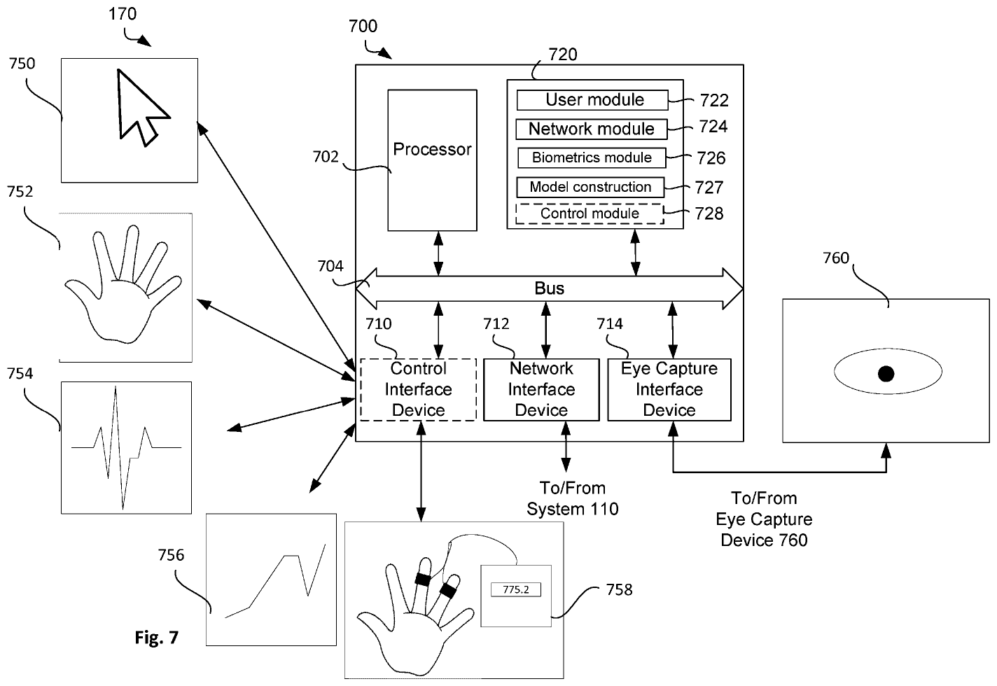

In this sense and as illustrated in FIG. 6, computer system 210 performs a method 600 for generating a user-specific user interface. This method comprises a learning phase and an execution phase. In the learning phase, system 210 presents 602 one or more pre-defined tasks to a user and the pre-defined tasks include pre-defined task features. The tasks are pre-defined in the sense that they do not depend on the user behaviour but are provided to multiple users in the same or a similar form. The tasks may comprise the task of completing a questionnaire, evaluating a product (as described above for the example of selecting a blender) or other tasks. The task features can include any feature that is related to the task, such as product category and others described herein. System 210 then captures 604 user interaction features while the user completes the pre-defined tasks, including mouse movement, eye movement etc. as described herein.

The system also captures 606 a user decision input indicative of a decision by the user on the one or more pre-defined tasks, such as answers to questionnaire questions or selected products. System 210 then constructs and trains 608 a user-specific trust model that models the relationship between the pre-defined task features, the user interaction features and the user decision input.

Next, during the execution phase the system 210 evaluates 610 the created user-specific trust model on current task features, that is features of tasks that the user is currently facing but that are not necessarily pre-defined. That is, the outcome of these tasks is not yet known. Based on evaluating the user-specific trust model on the current task features the system 210 selectively includes 612 user interface elements into the user interface to thereby generate a user-specific user interface. For example, system 210 only includes user interface elements that are trusted by this particular user. This may also comprise offering particular products that have these user interface features that are trusted. For example, different pizza ovens may have different controls and system 210 only shows those pizza ovens that have trusted controls for this particular user.

As the initial step to construct the trust model for a user, the user is first presented with standard tasks. The parameters of the task, e.g. task difficulty, and way of presentation can be manipulated to induce different user decisions and subjective trust levels (both can be collected using questionnaires). At the same time, user behaviours and physiological signals related to the user decisions are recorded. As the second step to construct the trust model for a user, the user's behaviours, decisions, trust levels and the corresponding task parameters are utilized together to train models with supervised machine learning methods, where decision tree learning model is just one example.

As the user trust model depicts the relationship between user behavior, task parameters and the resulting user decisions and trust levels, it can be utilized in three means:

For a given new task, take the user's behavior and task parameters as inputs, to evaluate the user's trust;

For a given new task, take the task parameters as inputs to predict user's decisions;

For a given new task, take the user's behavior and/or task parameters as inputs, to predict the user's performance.

### Predicted User-Machine Performance

The reliability model can be used to predict how the user and machine can interact or co-operate as a team. This means that reliability model can ascertain what types of machine errors can be tolerated by the user. For example, a user who is a pilot operating a plane may tolerate autopilot errors in the take-off and landing phases because the pilot has complete control of the aircraft at that point and the autopilot is used as informative rather than for automation. On the other hand, any autopilot errors while the aircraft is cruising at a high altitude will not be tolerated because the autopilot has significant control of the aircraft (although can still be manually overridden if necessary).

### User Trust Model Application

The constructed model is able to determine which of the given features are more powerful in discriminating the user's trust levels. That is, the model can be inspected to determine which features affect the user's trust levels the most. As a consequence, the model, using a set of most effective features, is able to predict the user decision with probabilities, for example, for a set of given websites that the user might be interested in. That is, if the user's operations can be observed, then the user's final decision can be predicted.

Furthermore, based on the user's behavioural features, other trusting information including the trusting ratings and preference on the different products can be predicted. A further step will be to recommend products that are only of interest to the user, as the behaviour features can also be used to train a similar model to determine the trusted content and the contents that the user does not trust, and thus selectively show only trusted content to the user.

FIG. 7 illustrates a computer system 700 capable of performing the methods disclosed herein. Computer system 700 comprises a processor 702 connected via a bus 704 to a control interface device 710, a network interface device 712 and an eye motion capture interface device 714. Bus 704 also connects processor 702 to a memory 720, which has stored program code thereon, which cases the processor 702 to perform the methods disclosed herein. The program code comprises a user module 722, a network module 724, a biometrics module 726, a mode construction module 727 and a control module 728. The control interface device 710 is connected to a mouse cursor movement detector 750, a hand movement sensor 752, a heart rate sensor 754, a body temperature sensor 756 and a finger moisture sensor 758. The eye capture interface 714 is connected to an eye capture device 760.

### EXAMPLE

User K wants to buy a new pizza oven for his new home, but he has never tried one before. User K has used many different types of microwave ovens, stoves, microwave ovens before.

Due to the difficulty to decide which pizza oven to buy, a trust-related session is conducted at User K's home to help him. He is asked to operate on several selected electric devices, and rate how much he trusts each function of the device, and his behaviours are also recorded with a camera.

A specific trust model is constructed for User K based on the collected data, regarding what information he has used (e.g. checking the colour of food in the microwave oven), how much he trusts the device (based on real-time surveys), and what is his next decision (e.g. override the automatic function, or just let it be), and how satisfied with the final outcome (e.g. the taste of the food).

For any given pizza oven, its functions are mapped to User K's trust model respectively and automatically, and thus the pizza oven with the optimal combination of functions is automatically found online, which is expected to meet User K's maximum trust.

Similar technologies can be used to help User K to find what kind of online information is trustworthy to him (not necessarily trustworthy to others)—which may require the training of another trust model in the web browsing context.

### Advantages

An accurate match between user and service/information/device

The calibration of trust, and application of trust model to decide whether a device can gain a specific user's trust, whether some information or service is suitable for a specific user's trust profile. A direct impact is that information delivery mechanism can be customized to fit the needs of different users.

User decision facilitation:

For a given user, based on the trust profile, the use decision can be predicted somehow, which can be potentially a useful tool to extend the way that human interacts with computers: the decision execution efficiency can be much improved, in an automatic way.

User trust quantification:

This technology aims to quantify the trust of users, and via the qualitative comparison of the trust levels of different users, it will facilitate product design in that the designers can make accurate decisions on which feature will enhance the trust of one specific category of users.

### Applications

The methods described herein may be used for the following applications:

A method for user trust calibration, trust model construction, trust measurement and user decision/performance prediction.

A framework for trust model construction, where the key input data include the behaviour of users, the decision user have made, the characteristics of the task and context, and the reported/observed trust level of the user.

A method to use the constructed trust model to determine, for a given task in a given context, how much trust the user may have on the given information or to the collaboration partner.

A method to use the constructed trust model to predict, for a given task in a given context, what decision may be made by the user according to the detected trust level.

A method to use the constructed trust model to predict, when the user teams up with a machine, what will be the team performance according to the acquired trust knowledge.

A trust examination platform for users when accessing online information:
Current online information is created & updated in huge amounts every second, however a user may not trust them all. Given the limited time the user can spend on the online content access, the method disclose herein will make it possible that only contents trusted by the user will be accurately delivered to her/him.

Trust examination for cybersecurity applications:
Cybersecurity is an ongoing concern, for which trust is a key component. The disclosed methods measure users' trust level, as a means to decide their exposed risk to malwares, phishing emails and other formats of cybersecurity attacks.

Large scale data collection for user trust modelling and quantification:
Collect large scale of user data using crowdsourcing platforms, e.g. CrowdFlower, to build generic models of users' trust and decision making procedure.

Trust matching between human & machine:
The measured trust levels can be matched to the target machines, for example, for a specific user, what kind of automatic machine learning systems, which characteristics of an online search system, or what category of machine partner can match her/his trust profile.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for generating a user-specific user interface, the method comprising:
a learning phase comprising:
presenting one or more pre-defined tasks to a user, the pre-defined tasks including pre-defined task features,
capturing user interaction features while the user completes the pre-defined tasks,
capturing a user decision input indicative of a decision by the user on the one or more pre-defined tasks, and
creating a user-specific trust model that models the relationship between the pre-defined task features, the user interaction features and the user decision input; and
an execution phase comprising:
evaluating the user-specific trust model on current task features; and
based on evaluating the user-specific trust model on the current task features, selectively including user interface elements into the user interface to thereby generate a user-specific user interface.

2. The method of claim 1 wherein the learning phase further comprises determining critical features from the pre-defined task features; and creating a user-specific trust model that models the relationship between the critical features, the user interaction features and the user decision input.

3. The method of claim 1 wherein the one or more pre-defined tasks are presented to the user through a first user interface and the current task features are provided through a second user interface.

4. The method of claim 3, wherein the first user interface is different from the second user interface.

5. The method claim 4 wherein the first interface is associated with a first device and the second interface is associated with a second device, wherein the first device is different from the second device.

6. The method of claim 1 wherein the user interface comprises one or more of:
graphical user interface;
a machine or device user interface; and
an online shop interface.

7. The method of claim 1 wherein the user interface elements are sale items.

8. The method of claim 1, wherein the user interface elements are options or controls.

9. A computer implemented method of predicting a decision of a user, the method comprising:
receiving first task data associated with a first task performed by the user;
determining a reliability level based on the first task data;
determining a reliability model for the user based on the reliability level;
receiving second task data associated with a second task performed by the user; and
predicting a decision of the user based on the reliability model and the second task data.

10. The computer implemented method according to claim 9 wherein the second task data is associated with a device.

11. The computer implemented method according to claim 10 wherein the prediction of the user comprises predicting a decision of the user to control the device.

12. The computer implemented method according to claim 9 further comprising determining first user decision data based on the first task data.

13. The computer implemented method according to claim 12 further comprising determining user behaviour data based on the first task data.

14. The computer implemented method according to claim 13 wherein determining the reliability model is based on the first task data, the reliability level, the first user decision data and user behaviour data.

15. The computer implemented method according to claim 9 further comprising predicting the reliability level and predicting the user machine performance and wherein an output of a computer system is changed based on one or more of:
the predicted decision of the user;
the reliability level; and
the user-machine performance.

16. The computer implemented method according to claim 15 wherein changing the output of the computer system includes changing the user interface to manage the flow of information.

17. The computer implemented method according to claim 9 wherein the reliability model for the user is constructed by supervised machine learning methods.

18. The computer implemented method according to claim 17 where the inputs to the reliability model comprise one or more of:
task parameters for a set of standard tasks;
user behaviour based on the first task data;
user decision based on the first task data; and
reliability level based on the first task data.

19. The computer implemented method according to claim 1 further comprising receiving data representing physiological signals of the user and wherein the user behaviour includes physiological signals.

20. A non-transitory computer readable medium including computer-executable instructions stored thereon that when executed by a processor causes the processor to perform the method of claim 1.

21. A computer system for predicting a decision of a user, comprising:
a processor:
to receive first task data associated with a first task performed by the user;
to determine a reliability level based on the first task data;
to determine a reliability model for the user based on the reliability level;
to receive second task data associated with a second task performed by the user; and
to predict a decision of the user based on the reliability model and the second task data.
